(19) United States
(12) Patent Application Publication
(10) Pub. No.: US 2018/0290473 A1
(43) Pub. Date: Oct. 11, 2018

(54) UNPRINTING ENGINE

(71) Applicant: REEP TECHNOLOGIES LTD., Kochav Yair (IL)

(72) Inventors: David LEAL-AYALA, Cambridge (GB); Anthony DUNN, Cambridge (GB)

(21) Appl. No.: 15/557,834

(22) PCT Filed: Mar. 11, 2016
(86) PCT No.: PCT/GB2016/050662

§ 371 Date: Sep. 13, 2017

(30) Foreign Application Priority Data
Mar. 13, 2015 (GB) 1504271.6

(51) Int. Cl. B41M 7/00; B41J 29/377

(52) U.S. Cl. CPC B41M 7/0009; B41J 29/377

(57) ABSTRACT

We describe a print removal device for removing print from a print-carrying medium. In embodiments the print removal device comprises: a feed system for receiving the print-carrying medium and guiding the print-carrying medium through the print removal device; and a system to remove the print from the print-carrying medium, in particular a laser light source for providing a controllable laser light beam to remove the print from the print-carrying medium. Previously used paper for “unprinting” may not be flat and well-behaved, and access may be needed to the full width of the paper creating a section where physical guiding is compromised, and thus the feed system comprises a media guide with an inflection configured to bias the print-carrying medium towards a face of the print-carrying medium which faces away from the laser light source when the print-carrying medium is guided through the print removal device also having the benefit to control the media more accurately to the preferred optical focus plane. We also describe some preferred optical and other device configurations.

### FIELD OF THE INVENTION

This invention relates to apparatus and methods for removing print, such as toner ink, from a print-carrying medium, such as paper, (“unprinting”).

### BACKGROUND TO THE INVENTION

We have previously described a combination of laser pulse length and wavelength which optimises the removal of toner ink from white paper, in Leal-Ayala D. R. and Allwood J. M., “Paper re-use: Toner-print removal by laser ablation”, International Conference on Digital Printing Technologies (2010), pages 6-9; and also in Leal-Ayala, D. R., Allwood, J. M., Schmidt, M., & Alexeev, I. (2012), “Toner-print removal from paper by long and ultrashort pulsed lasers”, Proceedings of the Royal Society A: Mathematical, Physical and Engineering Science, 468(2144), 2272-2293. FIG. 1, which is taken from the Proc. Roy. Soc. paper, illustrates the relationship between wavelength, pulse length and paper damage, showing that the optimum wavelength is in the visible, around the green, and that the optimum pulse length is in the range 1-40 ns. Further background prior art can be found in U.S. Pat. No. 8,693,064; U.S. Pat. No. 5,489,158;US2004/0080787; US2012/0268799; and WO95/00343; JP2005/292747A also appears to describe a paper sheet regenerating device.

We have previously described in our pending GB patent application 1423033.8 how to solve various practical engineering problems in order to make a practical, commercial print removal device (“unprinter”). Broadly speaking, an “unprinter” is a system or apparatus which comprises a laser device in combination with a positioning sensor to effectively remove (i.e. “unprint”) toner print from an item of media (e.g. paper). Toner particles are removed from paper by laser ablation. The “unprinter” system and the process to “unprint” toner print are described in more detail in GB patent application 1423033.8, which is incorporated herein by reference in its entirety.

However, there is a need for further improvements of such print removal devices.

### SUMMARY OF THE INVENTION

According to one aspect of the present invention, there is therefore provided a print removal device for removing print from a print-carrying medium, the print removal device comprising: a laser light source for providing a controllable laser light beam; and a controllable reflector for reflecting said laser light beam onto said print-carrying medium to remove said print from said print-carrying medium.

The inventors have realised that by providing a reflector in the print removal device, it is no longer necessary to provide a print removal head comprising a laser light source, in which a lateral position of the print removal head is controlled to move the laser light source over the print-carrying medium. Instead, the laser light beam is provided by a laser light source which may be fixed in the print removal device. A position of laser light beam impinging on the print-carrying medium may be varied by controlling the reflector. Since in embodiments there is no need for controlling a position of the laser light source, a complex control system for controlling the laser light source is made redundant. By intersecting the laser light beam, the beam may be reflected by the reflector towards the print-carrying medium.

Furthermore, since moving the position of a heavy laser light source would result in high power consumption, the power consumption of the print removal device according to embodiments described herein is advantageously reduced.

Further still, moving a heavy laser light source may be relatively slow. Therefore, by providing a reflector whose position and/or tilt may be varied, whereby the reflector is relatively light compared to a laser light source, the “unprinting” process may be performed at a higher rate.

A further advantage of exploiting a reflector, which may be controlled as will be further outlined below, is that the reflector (or where a carrier for the reflector is used, the carrier) may be close to the print-carrying medium, thereby reducing the size of the print removal device. By comparison, a laser light source on a carrier would increase the volume of the print removal device above the print-carrying medium significantly.

It is noted that references to print throughout the description comprise, for example, toner, ink, pen marks, pencil marks or any other kind of print/mark/writing/image on the print-carrying medium which is known to those skilled in the art.

One or more baffles may be provided in the print removal device so as to protect the reflector, and/or the laser light source, and/or other devices of the print removal device, in particular optical devices, from dust or print removed with the laser light beam. These are preferably deployed in positions so as to act in cooperation with any directional airflow created by a forced air extraction system.

The laser light source is connected to a power supply.

In a preferred embodiment, the print removal device further comprises a print sensor for sensing a position or area occupied by the print on the print-carrying medium. The print removal device may further comprise a controller, such as a microprocessor under stored program control, coupled to the sensor to control the controllable reflector to reflect the laser light beam onto the print-carrying medium to remove the print from the print-carrying medium in response to said sensing.

In embodiments, the resolution of the print sensor is between 300 dpi and 600 dpi.

The total time for “unprinting” a print-carrying medium may thereby be reduced by not scanning, with the laser light beam, areas that do not need to be “unprinted”.

In a preferred embodiment of the print removal device, controlling of the controllable reflector comprises one or both of: controlling a position of the reflector in a first direction having a component which is perpendicular to a direction of movement of the print-carrying medium in the print removal device, wherein the first direction is substantially parallel to a plane of the print-carrying medium; and rotating the reflector for varying a second direction of the reflected laser light beam.

Rotating the reflector is to be interpreted as to any change of orientation of the reflector which results in the laser light beam being reflected in a different direction. The reflector may be rotated continuously or it may be rotated back and forth.

The controllable reflector may, in embodiments, be driven over the print-carrying medium in a direction which is substantially perpendicular to a direction of movement of the print-carrying medium in the print removal device. Preferably, the reflector is moved from side to side covering the entire width of the print-carrying medium. Alternatively or additionally, the reflector may be rotated or tilted such that the laser light beam may be reflected into a different direction to allow different areas of the print-carrying medium to be exposed to the laser light beam. Whenever reference is made in this description to rotating the reflector, this also refers to tilting the reflector, and more generally to any change in the direction of an axis, in particular the normal axis, of the reflector to reflect the laser light beam into a different direction.

The reflector may be controlled with a motor, in particular a DC motor, which may have a position/speed feedback encoder. The motor may be integrated in the print removal device (with or without control system), or an external linkage may be provided to drive the transport, for example linked via a belt, shaft or gears. The reflector may, preferably, accelerate or decelerate at acceleration/deceleration regions at each end of the travel from side to side of the width of the print-carrying medium. An elongated bearing may be provided on the carrier to minimize undesirable rotation of the carrier and to provide a stable, vibration-free operation of the carrier/reflector. Cooling vanes may further be provided on the carrier. A position and/or tilt of the reflector may be controlled using a projection riding on a rail.

The reflector may be mounted on a controllable carrier. The reflector may be integral to the controllable carrier.

Preferably, the carrier may be a low-mass carrier which may allow for a reduction in power consumption when controlling a position and/or tilt of the carrier, and therefore the reflector. Using a low-mass reflector and, where employed, a low-mass carrier allows for quick movement of these components with little inertia and low power consumption.

The carrier of the reflector may be as close to the drive point as possible to minimise rotational torque when accelerating and decelerating the carrier. A counterweight may be integrated into the carrier to further balance the load of the reflector and its mount. The close packing may allow for the overall mass (including that of the counterweight) to be reduced.

The reflector may be, for example, a mirror, a prism, or the like. Preferably, the reflector is of low cost and at the same time of high reflectance. For example, in embodiments, the reflector may comprise a composite material comprising one or more of beryllium, aluminium and silica, and may be prepared as solid or as fused particles, preferably post-machined and with an evaporated reflective coating. The skilled person will be familiar with materials and processes for obtaining low-cost, high-reflective reflectors. A small reflector is preferable since the smaller the reflector, the faster it may be moved in the print removal device. It will be appreciated that the mirror is preferably at least as large as the laser spot size allowing the entire laser beam to be reflected.

In a preferred embodiment, controlling and/or rotating the reflector allow for two or more laser light beam-exposed regions of said print-carrying medium to overlap, for example by 10% to 80%, in particular where the laser is pulsed (where the overlap may be defined with reference to a standard beam width measurement such as the full width at half maximum (FWHM), 1/e² width (where the intensity drops to 13.5% of its maximum value), D4σ (second moment) width or ISO11146 width). An overlap of regions which may be exposed to the laser light beam may allow for providing a full coverage of the print-carrying medium. The overlap may be varied such that any given area or location of the print-carrying medium may be exposed once or multiple times.

In embodiments the controllable reflector is controlled to scan the laser along lines perpendicular to a direction of travel of the print-carrying medium, and the controllable reflector is controlled to overlap spots of the pulses by a first percentage (for example in the range 10% to 80%) along a scan line and by a second different percentage (also, for example, in the range 10% to 80%) between two adjacent scan lines. The second percentage may be different, for example greater than the first percentage. In broad terms the inventors have discovered that a dynamic process operates during print ablation such that when two adjacent spots are ablated along the same scan line the ablation of one affects the next, whereas this effect is less noticeable between adjacent scan lines (where the delay between overlapping ablation events is longer). In embodiments the aim is that a scan line is substantially completely ablated before the next line is processed.

In embodiments the laser spot size may be relatively small, for example in the range 0.05 to 0.5 mm, more particularly 0.1 to 0.2 mm, to increase the laser fluence. However this small spot size introduces difficulties in scanning the beam, due to the rapid scan speed and precise mechanical tolerances necessary. To meet these constraints it has been found that use of a high speed laser scanner is desirable, such as a galvanometer scanner or spinning polygonal mirror. Where the beam is scanned in this way the beam profile may change across a scan line, for example from a generally circular to a more elliptical shape. Optionally distortion-correction optics may be included to correct for this and/or the pulse timing (duration and/or interval between pulses) may be adjusted to compensate.

In some embodiments, the laser light beam has a generally circular spot shape. It has been found that in these embodiments, an optimum separation of adjacent laser light beam pulses (i.e. distance between centres of two neighbouring spots) for speed of “unprinting” an entire surface of a print-carrying medium is approximately 2^{-1/2} times the spot diameter for a circular spot. This means that where the quality and energy of the laser light beam spot are sufficient to “unprint” with a single exposure, the square fitted within the circular spots may be abutted, as will be further described below.

In a preferred embodiment, the reflected laser light beam impinges on the print-carrying medium substantially at a right angle. Therefore, preferably, the laser light beam has an optimal shape and a uniformity of power above a threshold (beam quality) such that it can be reflected through a right angle by a flat reflector, thereby maintaining the characteristics of the laser spot.

The reflector is thereby preferably disposed to move perpendicular to the direction of movement of the print-carrying medium through the “unprinting” area. The motion of the reflector is preferably parallel to an axis of the collimated, non-divergent laser light beam, thereby projecting the laser light beam onto the print-carrying medium surface to give substantially the same spot characteristics at all locations across the print-carrying medium as the reflector sweeps across it. In a preferred embodiment, the laser light beam is therefore provided by the laser light source in a direction which is substantially parallel to a plane of the print-carrying medium and substantially perpendicular to a direction of motion of the print-carrying medium in the print removal device. When using a substantially flat reflector, the angle of incidence of the laser light beam onto the reflector may be approximately 45 degrees so as to maintain the spot shape of the laser light beam when impinging on the print-carrying medium.

As outlined above in embodiments the laser light beam is round. The reflector may have a rectangular shape as it may need to be longer than the diameter of the laser light spot due to the angle of inclination. The reflector does not necessarily have to be rectangular as a rectangular reflector would have excess unused material in the other dimensions which need only be as wide as the laser light spot. This may advantageously reduce mass and cost of the reflector.

In a further preferred embodiment, the reflected laser light beam has a shape which is longer in a fourth direction than in a fifth direction when impinging on said print-carrying medium, wherein the fourth direction is substantially parallel to a direction of movement of the print-carrying medium in the print removal device and wherein the fifth direction is substantially perpendicular to the direction of movement of the print-carrying medium in the print removal device.

An advantage of a laser light beam spot or line having a relatively long dimension in the axis of print-carrying medium movement is that the mechanical alignment is less demanding in order to allow abutting or overlapping of adjacent areas exposed by the laser light beam. For example, where the laser line length or spot width is large relative compared to mechanical tolerances, the positioning of the print-carrying medium within the print removal device may be tolerated to up to 0.1 mm, or preferably up to 0.5 mm.

A distortion of the laser light beam may be achieved in various ways. On the one hand, the reflector may be inclined at an angle (i.e. rotated as outlined above) to distort the laser light beam spot shape. Alternatively or additionally, the reflector is not flat, but may be convex, concaved, curved or may have another complex form to distort the laser light beam. For example, an approximately circular spot shape of the laser light beam impinging on the reflector may be converted into an elongated shape when reflected by the reflector, to thereby support a wide swath at the same time as concentrating energy into a reduce area.

It will be appreciated that when the reflector is tilted to direct the reflected laser light beam to various positions on the print-carrying medium, the distortion, if not desired, may be minimized by increasing the separation between the print-carrying medium and the reflector.

In still further embodiments the transverse profile of the laser light beam is flattened so that it has steeper sides (for example from a Gaussian towards a super-Gaussian profile) and/or modified such that it more closely approximates a square or rectangle (or more generally is non-circularly symmetric). This helps achieve rapid coverage of an area to be ablated (preferably with some overlap between adjacent spots as previously described). Thus in embodiments an optical system of the print removal device may incorporate an optical element, such as a diffractive optical element, to modify the transverse beam profile to flatten the profile and/or make the beam “squarer”, or the laser may be selected to provide a beam profile as described above. The beam profile may be defined at any convenient intensity level as previously described, for example the 1/e² level.

A cowl may be provided which encloses at least the reflector moving along the swath line with a linkage to drive from outside the cowl. The slot for the driving linkage to pass through and slide along may also serve as an air inlet or act as a secondary air inlet/leak path. Moving shuttering or brushes may be provided to limit the opening whilst allowing the linkage to slide along.

In a further preferred embodiment, the print removal device further comprises a collection unit for collecting the removed print. The collection unit may, in embodiments, comprise one or more filters for filtering particles of the removed print debris. The one or more filters may, for example, be carbon filters and/or nano-particle filters.

In a further preferred embodiment, the print removal device further comprises an extraction system for extracting the removed print from an area of the print-carrying medium at which the print has been removed. The extraction system may be connected to the collection unit, as will be further described below.

We have previously described in our pending GB patent application 1408695.3 a scheme for extraction with a flexible pipe/hose and a nozzle moving with the laser head on a carriage, which is incorporated herein by reference in its entirety.

In a preferred embodiment, the extraction system is configured to provide an air-flow in the print removal device, wherein the air-flow carries particles of the removed print, and wherein an air-flow direction of the air-flow is substantially perpendicular to a beam direction of the controllable laser light beam provided by the laser light source. Providing an air-flow in a direction substantially perpendicular to the laser light beam direction advantageously allows for protecting the laser light source and/or the reflector from accumulation of removed print debris (and/or dust). Cleaning mechanisms which would add complexity to the system, and would otherwise be necessary for cleaning in particular optical devices of the print removal device, may therefore be omitted in embodiments of the present print removal device. The preferred air-flow direction further allows for avoiding effects of leakage causing inconsistent extraction of air flow along the length of the path perpendicular to the print-carrying medium movement direction to/from the medium path. This may result in an extraction of air-flow arranged parallel to the motion of the reflector, resulting in a higher air-flow at one end than the other. A further key benefit arises as the air-flow is applied transversally across the swath line and carrier. This allows the air-flow to be well-balanced across the entire “unprint” swath. Any effects of air leakage from this path to the paper track are likely to be similar across the length of the “unprint” swath, therefore allowing a lower peak air-flow than if the air-flow were along the line of the “unprinting” swath. Another key benefit of having the air-flow in the direction of movement of the print-carrying medium is that the air-flow is perpendicular to the laser light beam, meaning that it can be baffled to flow past and around the optical input port and the reflector without obstructing them.

The “unprinting” process with a laser ablates the print into the immediately surrounding air. It is therefore desirable to extract and collect the print once it has been removed.

In a related aspect of the invention, there is therefore provided a print removal device for removing print from a print-carrying medium, in particular the print removal device as outlined in any of the embodiments above, the print removal device comprising: a system to remove the print from the print-carrying medium along a swath line, in particular a laser light source for providing a controllable laser light beam; an extraction system for extracting particles of the removed print; and a collection chamber connected to the extraction system, wherein the collection chamber is configured to collect removed print debris extracted by the extraction system; wherein the extraction system includes an air inlet having an inlet aperture shape adapted to match the swath line, to entrain the particles of removed print from the swath line; and/or wherein a cross-sectional area of air flow through the extraction system enlarges at a collection chamber region such that a speed of the air flow reduces to promote settling of the particles in the collection region.

The collection chamber may be an enlarged collection chamber (“debris chamber”) which may accommodate large volumes of “unprinting” waste from ablation of print. In some embodiments, the collection chamber may comprise a serpentine flow path to permit settling of the removed print debris in the collection chamber. Additionally or alternatively, baffles may be provided for further enhancing settlement of the removed print debris in the collection chamber.

In some embodiments, a narrow, elongated opening adjacent to the laser swath line may be provided in order to extract removed print (debris) from a section or all of the “unprinting” swath. The narrow opening allows increased air-flow over the region of the print-carrying medium which is exposed to the laser light beam to provide extraction. The opening may be formed by a manifold, which may for example be injection moulded or otherwise formed at low cost to enclose the air-flow and also provide guiding for the print-carrying medium.

The narrow, elongated opening for drawing air and ablation debris along the “unprint” swath by constraining the cross-sectional area advantageously increases an air-flow across the area of interest. An air-flow path may be provided from the narrow, elongated opening to the extraction system.

A cowl, for example the cowl as outlined above, in which the manifold may be arranged, may provide for shielding from the laser light beam.

The manifold may further locate media drive or nip components such as rollers which may be sprung against cooperating components on the other side of the media path to provide a pinch drive to the media. The manifold may also form one or more parts of the media guide. Furthermore, the manifold may locate sensors such as image sensors, edge detectors, thickness detectors, code readers or other devices.

It may be preferable to slow down particles of the removed print in the collection chamber to thereby collect the majority of particles in the collection chamber.

Therefore, as outlined above, in embodiments a cross-sectional area of air flow through the extraction system enlarges at a collection chamber region such that a speed of the air flow reduces to promote settling of the particles in the collection region. The speed of air-flow in the collection chamber is therefore reduced compared to the air-flow in the extraction system, which slows down the particles when they arrive in the collection chamber. The cross-sectional area of the collection chamber may therefore be larger than those of an inlet nozzle of the extraction system and of a linkage (conduit, duct or pipe) of the extraction system connecting the inlet nozzle with the collection chamber.

The air-flow rate in the collection chamber is therefore rapidly reduced. Preferably, baffles may be provided in the collection chamber (and/or the extraction system) to extend the air-flow path, to thereby collect the majority of particles in the collection chamber. This is particularly advantageous when one or more filters are provided in addition to the collection chamber, as described below.

It will be appreciated that one or more collection chambers (in sequence) may be exploited. Even though using a plurality of collection chambers in sequence may increase the volume of the print removal device, this may still be advantageous as the air-flow in the collection chambers may be progressively slowed down to increase accumulation of the removed print in the collection chambers prior to any filter(s) which may be exploited to collect fine particles.

In a further preferred embodiment, the print removal device further comprises one or more filters, wherein the collection chamber is arranged between the extraction system and the one or more filters. Where collection chamber and one or more filters are used, it is particularly preferable to slow down the particles as outlined above once they arrive in the collection chamber to collect the majority of particles of the removed print in the collection chamber. A lifetime of the one or more filters may therefore be advantageously improved as they may filter a lesser amount of particles. At the same time, the collection chamber has a comparatively large volume so that the majority of the removed print may be collected in the collection chamber, rather than filtered by the one or more filters.

Collecting the majority of particles in the collection chamber may be further advantageously enhanced using other means, as will be described below.

In a related aspect of the invention there is therefore provided a print removal device for removing print from a print-carrying medium, in particular the print removal device as outlined in any of the above embodiments, the print removal device comprising: a system to remove the print from the print-carrying medium; an extraction system for extracting particles of the removed print; and a collection chamber connected to the extraction system, wherein the collection chamber is configured to collect removed print debris extracted by the extraction system, wherein the collection chamber comprises an electrical element for applying an electric field to particles of the removed print received from the extraction system in the collection chamber for electrostatic collection of the particles. The particles themselves may or may not be electrically charged. Even if the particles are not charged, they may be attracted to the electrical element due to their dipole moment.

It will be appreciated that one or more of the electrical elements may be exploited in the collection chamber. The electrical elements may be tracks on a printed circuit board, for example a flexible printed circuit board. Alternatively or additionally, the electrical element(s) may be provided as a wire or wires.

The electrical element may be, for example, one or more conductive or charged wires. These elements, as outlined above, may be used to apply a biasing electrostatic potential to attract debris particles. The cowl may protect the user of the print removal device from a (potentially) relatively high voltage applied to the electrical element(s). The electrical element(s) may be press fitted through interface slots in the enclosure or may be inserted into the collection chamber when it is moulded or otherwise manufactured. Alternatively, the electrical element(s) may be formed on a circuit board which may be conventional and/or flexible or of a flexi-rigid type forming the connections both inside and outside the collection chamber.

Throughout the description, the system to remove print from the print-carrying medium may, for example, be a laser light source as outlined in embodiments herein. Alternatively, abrasion or a chemical technique may be used to remove print from the print-carrying medium. The skilled person will be familiar with alternative techniques for removing print, and it will be appreciated that a certain technique may be particularly suitable for removing a specific type of print.

The collection in the collection chamber may be further enhanced by charging the particles prior to their arrival in the collection chamber. Therefore, in a further preferred embodiment, the print removal device comprises a charging device for electrically charging particles of the print prior to receiving the removed print in the collection chamber, wherein the charging device is configured to charge the particles before and/or after the removal of the print by the system.

The charging device may comprise one or more conductive and/or electrostatic elements, for example a carbon brush which may be disposed in close proximity to, or touch, the print-carrying medium before the “unprinting” position so as to pre-charge the print-carrying medium and hence the print thereon. The print may be charged with an opposite charge compared to the electrical element(s) in the collection chamber to enhance attraction of the particles to the electrical element(s) in the collection chamber.

Additionally or alternatively, particles of the print may be charged in the air-flow path between the area at which the print has been removed and the collection chamber. For example, one or more charged plates may be provided in the air-flow next to the ablation area and/or at one or more locations in the air-flow path between the ablation area and the collection chamber to charge the particles prior to their arrival in the collection chamber.

Where the print-carrying medium is charged before ablation, then conductive elements (for example a carbon brush) may be disposed in close proximity, or touch, the print-carrying medium after ablation, whereby the conductive elements may be at earth potential so as to discharge areas of the medium which have passed the ablation area.

The collection chamber and/or the filters, which may be combined in a single unit rather than being separate, individual elements, may be replaced once a certain amount of removed print debris has been collected. It may also be replaced if the element is malfunctioning. It may therefore be desirable to predict and/or indicate when an element of the collection system (which may comprise the collection chamber and/or one or more filters) should be replaced.

In a related aspect of the invention, there is therefore provided a print removal device for removing print from a print-carrying medium, in particular the print removal device as outlined in any of the embodiments above, the print removal device comprising: a system to remove the print from the print-carrying medium; a collection system configured to collect the removed print; and a replacement determination system for predicting and/or indicating when an element of the collection system should be replaced. As outlined above, it may be desirable to predict when and/or indicate that the element should be replaced due to an amount of the removed print collected in the collection system and/or due to a malfunctioning element.

In a preferred embodiment, the print removal device comprises a laser light source for providing a controllable laser light beam configured to remove said print from said print-carrying medium, wherein the collection system comprises one or both of a collection chamber and one or more filters. Embodiments of the print removal device therefore allow for predicting and/or indicating when an amount of print collected in the collection chamber and/or in the one or more filters is above a threshold (and/or when the collection chamber and/or the one or more filters are malfunctioning).

Various devices and methods may be used alone or in combination in order to predict and/or indicate when an element of the collection system should be replaced. Therefore, in a preferred embodiment of the print removal device, the replacement determination system comprises one or more of: a flow sensor for sensing an air-flow generated by a fan of the print removal device, wherein the air-flow carries particles of the removed print; an electrical sensor for measuring a power consumption and/or speed of the fan (directly or indirectly), for example by measuring current consumption; a pressure sensor for measuring an air pressure in the print removal device; a sensor for measuring a weight or volume of the collected, removed print; and a device for determining and/or counting one or more of: a total usage time of the laser light source, a total area of the print removed from the print-carrying medium, and a total number of unprinted print-carrying media.

The air-flow may reduce as the collection chamber and/or the one or more filters become clogged. This may be detected by the flow sensor as the air-flow may be below a first threshold. References to clogged (or nearly clogged) throughout the description refer equally to the collection system being full (or nearly full) of collected, removed print.

The fan of the print removal device may use less power because less mechanical work is being performed if the collection system is clogged. Hence, it may be detected that the power consumption of the fan is below a second threshold. Alternatively, the fan may be controlled such that a constant or nearly constant air-flow in the print removal device is guaranteed (or aimed for). In this case, if the collection system becomes clogged, the rate of the fan needs to go up, thereby consuming more power. Therefore, a clogged collection system (or nearly clogged collection system) may be detected if the power consumption of the fan is above a pre-defined threshold. Additionally or alternatively, the speed of the fan may be measured. This is preferably detected by sensing the electrical current to the motor or by measuring the fan motor's backwards electromotive force (back-EMF) developed, which is approximately proportional to speed. Whether the collection system is full (or nearly full) may therefore be predicted and/or indicated if the speed is above a threshold.

If there is no speed control on the fan the speed of the fan may go up if the collection system is (nearly) full, for example if a filter is clogged, as less work is done by the fan in moving the restricted air-flow. In this case, a prediction of a full (or nearly full) collection system may be made if the fan speed is above (or rises by more than) a threshold. Additionally or alternatively a flow sensor may be employed to detect reduced air-flow in the print removal device and hence make a prediction of a full (or nearly full) collection system.

It is to be noted that the one or more fans described throughout the specification may blow air or suck air to provide an air-flow in the print removal device.

It may alternatively or additionally be predicted and/or indicated that the collection system is full (or nearly full) if the pressure in the print removal device is above a threshold. This may be due to, for example, a filter which may be clogged while the fan is still generating an air flow in the print removal device, thereby building up pressure in the device. The pressure may be measured before, and/or after, and/or differentially across the fan(s) or filter(s).

The amount of the removed print debris collected in the collection system may alternatively or additionally be measured using a sensor which is integrated into the collection system. Whether the collection system is full (or nearly full) may therefore be predicted and/or indicated if the weight or volume of collected print is above a threshold.

The amount of removed print debris collected in the collection system may alternatively or additionally be determined by determining/measuring the total usage time of the laser light source, which may correlate to the amount of collected print debris. It will be appreciated that in embodiments the laser light source may only be used once print has been detected on a medium by a sensor, e.g. the sensor described in embodiments above. Therefore, if the total usage time of the laser light source is above a threshold, it may be determined that the collection system is clogged (or nearly clogged), and an element of the collection system should therefore be replaced. The total usage time may be given in hours, hours and seconds or other time periods.

Similarly, the total area of print removed from print-carrying media may additionally or alternatively be determined, as this may be a measure of the amount of removed print debris collected in the collection system. The total print area may be determined by integrating the area of all printed parts of the printed media processed over time. If the total area is above a threshold, it may be determined that the collection system is clogged (or nearly clogged), and an element of the collection system should therefore be replaced.

Similarly, the total number of print-carrying media (e.g. pages of paper) may additionally or alternatively be determined, as the total amount of print-carrying media from which print has been removed may be a measure of the amount of removed print collected in the collection system. Therefore, if the total number is above a threshold, it may be determined that the collection system is clogged (or nearly clogged), and an element of the collection system should therefore be replaced. It will be appreciated that this may be a less precise method of determining whether the collection system is clogged (or nearly clogged), as the information of the total number of pages does not necessarily correlated to the exact amount of print removed from print-carrying media. This is because some media may carry less print than others. In some embodiments, this may be accounted for by correlating a count of a single print-carrying medium to an average amount of print being removed from a print-carrying medium.

As outlined above, some areas of the print-carrying medium may overlap, therefore exposing some pixels or locations of the print-carrying medium multiple times. This may be taken into account when determining the total amount of print removed from the print-carrying medium by processing information about which areas have been exposed.

In a related aspect of the invention, there is provided a method for predicting and/or indicating when an element of a collection system for collecting print removed from one or more print-carrying media with a print removal device should be replaced, the method comprising removing the print from the one or more print-carrying media, in particular using a laser light source of the print removal device; the method further comprising one or more of:

a) sensing an air-flow in the print removal device, wherein the air-flow carries particles of the removed print;

b) measuring a power consumption of a fan of the print removal device, wherein the fan is configured to control the air-flow;

c) measuring a speed of the fan;

d) measuring a pressure in the print removal device;

e) measuring a weight or volume of the collected, removed print;

f) determining a total usage time of the laser light source;

g) determining a total area of the print removed from the one or more print-carrying media; and

h) counting a total number of print-carrying media from which the print has been removed,

the method further comprising predicting and/or indicating when the element should be replaced if one or more of:

1) the air-flow is below a first threshold;

2) the power consumption is below or above a second threshold;

3) the speed is above a third threshold;

4) the pressure is above a fourth threshold;

5) the weight or volume is above a fifth threshold;

6) the total usage time is above a sixth threshold;

7) the total area is above a seventh threshold; and

8) the total number is above an eighth threshold.

In a preferred embodiment, the method comprises alerting a user of the print removal device in response to the prediction and/or indication that the element of the collection system should be replaced. The print removal device may therefore comprise an indicator to signal the prediction and/or indication to the user. Preferably, the system may indicate in cases where multiple elements are used in the collection system, which (one or more) of these elements should be replaced.

In a related aspect of the invention, there is provided a print removal device for removing print from a print-carrying medium, in particular the print removal device as outlined in any of the embodiments above, the print removal device comprising: a feed system for receiving the print-carrying medium and guiding the print-carrying medium through the print removal device; and a system to remove said print from said print-carrying medium, in particular a laser light source for providing a controllable laser light beam to remove the print from the print-carrying medium; wherein the feed system comprises a media guide comprising an inflection configured to bias the print-carrying medium towards a face of the print-carrying medium which faces away from the laser light source when the print-carrying medium is guided through the print removal device.

In preferred embodiments, the laser light beam may transition from one side of the print-carrying medium to the other side, which may require unobstructed access from the reflector to the print-carrying medium (substantially) across its full width. It may also be undesirable to create such gaps in the media guide as they present edges that may cause flexible media, such as paper, in particular pre-used paper, to catch.

Therefore, providing a media guide comprising an inflection as outlined above allows for minimising or eliminating problems associated with a print-carrying medium being caught by such edges. The inflection which provides for the above-specified bias to the print-carrying medium advantageously allows minimising or eliminating non-uniformities in the laser power delivered to the print-carrying medium which may otherwise occur if features crossing the gap are deployed thereby obstructing the laser beam.

The laser may be unfocussed (but collimated), for example where the scanner comprises a mirror translating perpendicular to the paper movement direction (where the path length to the paper changes significantly with the transverse position of the mirror). However in some preferred embodiments the scanner is a high speed laser scanner as previously described, for example of the rotating/oscillating mirror type, in which case the laser beam may be focussed, which is advantageous for ablation.

A characteristic of a focussed laser scanning system is that the depth of field (the distance along the laser beam at which the intended image characteristics are to the desired specification or in focus) may be quite short. In some cases this depth of field may be similar to the height tolerance (variation in height) of the print-carrying medium as it is moves along the media guide. An inflection in the guide as described has the further benefit that the print-carrying medium position is controlled more precisely to a desired focal plane, providing a more controlled separation of the print-carrying medium to the reflector (although an inflection is not essential).

In more detail there may be a variation in path length from a focussing element, more particularly from the reflector, to the media as the beam scans across the width of the media. This variation depends upon the distance of the reflector from the media, which may, for example be in the range 200 mm to 800 mm. By way of example the path length variation may be ˜7-8 mm whereas the variation in media position (height) may be a few millimetres, for example ˜2 mm. By controlling the media height, in particular with upper and lower paper guide surfaces (which may be solid, ribbed or otherwise patterned) this variation may be significantly reduced, and the path length variation due to scanning may then be more easily accommodated by the optical design.

In embodiments the optical system may incorporate an optical element to compensate for the path length variation due to scanning across the width of the media. Preferably such an element is located after the rotating/oscillating mirror (or other scanning element); preferably the element is then located close to the scanning element to reduce its physical size. Such an optical element may comprise, for example, an F-theta lens.

In some preferred embodiments the laser beam is spread over a relatively large area of the scanning element (mirror) to reduce damage. Thus the optical system may incorporate beam expander, preferably located at or adjacent the laser source output. Additionally or alternatively a laser beam (profile) shaping element as described previously may be located at this position and/or combined with the beam expander.

Optionally the ablation region of the device may incorporate a diffuser plate located beneath the media location (as defined by the media guide(s)), along the scan line, to absorb laser energy if media for unprinting is absent.

It will be appreciated that in any of the embodiments described herein, the print removal device may be operated in a bi-directional mode. For example, the print-carrying medium may be guided from one side of the print removal device via the laser light exposure area to the other side. This may allow for removing print on a first surface of the print-carrying medium. The print-carrying medium may be turned around (automatically or manually) at the other side and guided through the print removal device to remove any print on the other surface of the print-carrying medium.

Therefore, in a preferred embodiment of the print removal device, the media guide comprises a first said inflection at a first location of the media guide and a second said inflection at a second location of the media guide, wherein the first and second locations are located on opposite sides, in a direction of the guiding of the print-carrying medium through the print removal device, with respect to an area of the print removal device at which the print-carrying medium is exposed to the laser light beam.

The plates or moulding forming the media guide on one or both sides of the slot at which the print-carrying medium may be exposed to laser light may be profiled to encourage the media to carry on in the track of the guide after the slot. This may be particularly important for used media which may, in extreme cases, have been rolled up.

In a preferred embodiment of the print removal device, the media guide comprises a plurality of wires for guiding the print-carrying medium through the print removal device, and wherein one or more gaps between the plurality of wires are configured to allow the print-carrying medium to be exposed to the laser light beam. Preferably, the wires are deployed at an angle so as not to be parallel with the motion of the print-carrying medium such that on adjacent swathes the laser light beam can access all parts of the print-carrying medium in an area of the print removal device at which the print-carrying medium is exposed to the laser light beam (i.e. the slot described above). The wires may be relatively thin, and may be made of, for example, stainless steel.

Optionally suction may additionally or alternatively be provided below the print-carrying medium, to pull the print-carrying medium down towards a supporting plate. However this is less preferably because of the potential effect on the air flow entraining the particles of ablated material for collection.

The skilled person will appreciate that the above described features and aspects of the invention may be used independently or in combination with one another.

### BRIEF DESCRIPTION OF THE DRAWINGS

These and other aspects of the invention will now be further described by way of example only, with reference to the accompanying Figures, wherein like numerals refer to like parts throughout, and in which:

FIG. 1 shows examples of wavelength and pulse length operating regions illustrating a preferred region of operation for unprinting;

FIG. 2 shows a schematic, cross-sectional side-view of a module of a first embodiment of an unprinter according to the present invention;

FIG. 3 shows a schematic, cross-sectional side-view of a module of a second embodiment of an unprinter according to the present invention;

FIG. 4 shows a schematic, perspective view of an unprinting module according to embodiments of the present invention;

FIGS. 5a and 5b show schematic, cross-sectional front and perspective views of an unprinter module according to embodiments of the present invention;

FIGS. 6 and 7 show schematic, cross-sectional side-views of an air-flow path in an unprinter module according to embodiments of the present invention;

FIG. 8 shows a schematic of a spot size illustration of a laser light beam according to embodiments of the present invention;

FIG. 9 shows distortion of a laser light beam according to embodiments of the present invention; and

FIG. 10 shows details of an unprinting module according to a further embodiment of the invention.

### DETAILED DESCRIPTION OF PREFERRED EMBODIMENTS

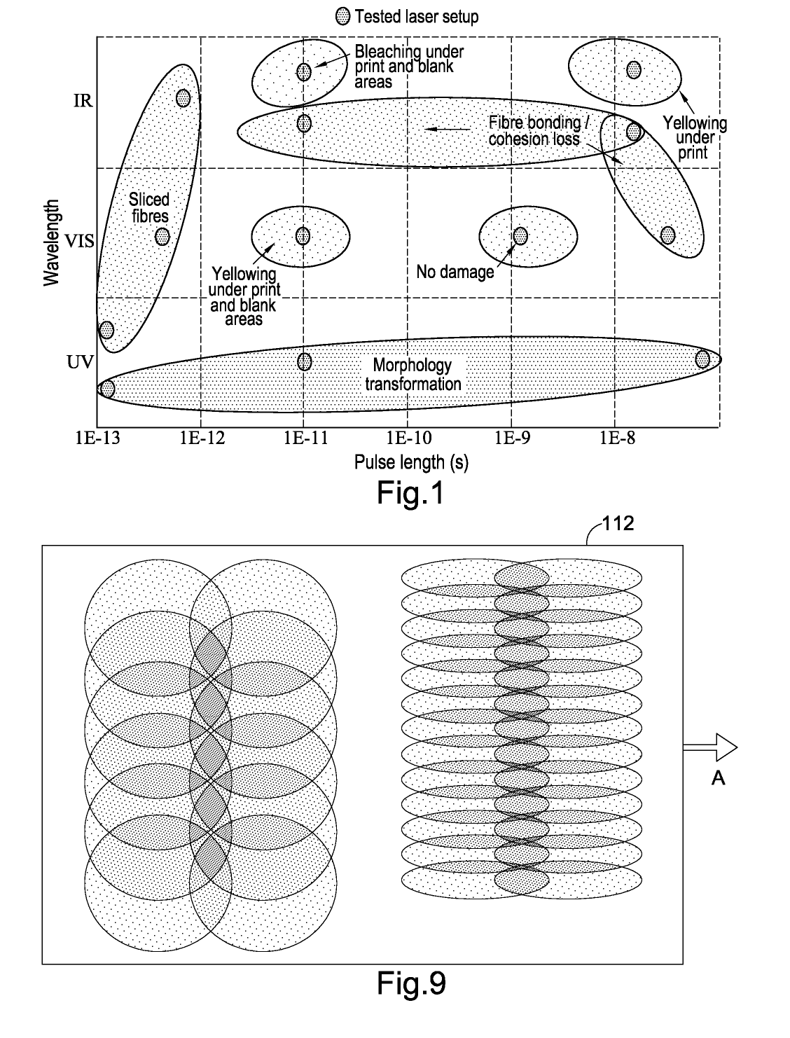

As outlined above, FIG. 1, which is taken from Proceedings of the Royal Society A: Mathematical, Physical and Engineering Science, 468(2144), 2272-2293, illustrates the relationship between wavelength, pulse length and paper damage, showing that the optimum wavelength is in the visible, around the green, and that the optimum pulse length is in the range 1-40 ns.

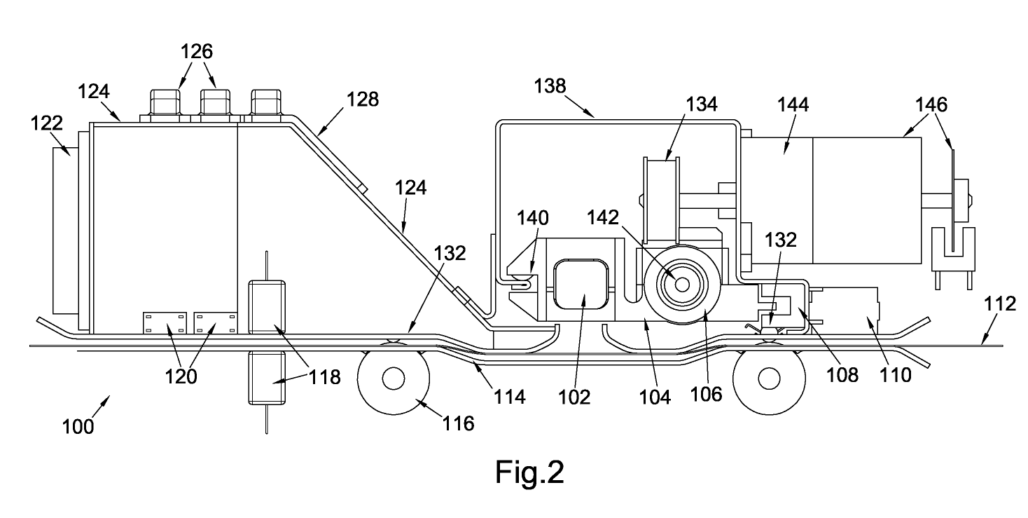

FIG. 2 shows a schematic, cross-sectional side-view of a first embodiment of an unprinter module 100 of an unprinter.

The unprinter module 100 has a mirror 102 which is configured to reflect a laser light beam (not shown in FIG. 2) onto a paper 112 which is fed through the unprinter.

In this example, the location of the mirror 102 is varied by driving it across the paper 112 using a carrier 104. The carrier 104 is mounted on an elongated carriage bearing 106, which itself is mounted on a carriage shaft 142. The elongated carriage bearing 106 minimises rotation and provides for a stable vibration free running on the carrier 104.

In this example, the carrier 104 is configured to position the mirror 102 at 45 degrees to the paper 112 to reflect the laser light beam injected through a side port (see below) perpendicular to the paper 112 onto the paper 112.

In order to vary the location of the mirror 102, the location of carrier 104 may be changed by driving a carriage drive belt 134 on pulleys. The carriage drive belt 134 is connected to a gearbox 144, which, in this example, is controlled by a DC motor and encoder unit 146. In this example, the gearbox 144 is integrated to the DC motor and encoder unit 146. The encoder comprises a position and speed feedback encoder formed, in this example, of a slotted disk and an opto-coupler.

Controlling the DC motor and encoder unit 146 therefore allows for controlling the speed and relative lateral location of mirror 102, in this example, in a direction perpendicular to the direction of movement of the paper 112 in the unprinter module 100. Hence, the laser light beam may be directed towards different areas on the paper 112.

In this example, a rail runner 140 is provided to guide and control rotation of the carrier 104 mounted on the carriage shaft 142, thereby setting the mirror 102 position. The rail runner 140 further prevents excess rotation during transport, for example when the unprinting module 100 is upside down in some transport means.

In this embodiment, mirror 102, carrier 104, elongated carriage bearing 106 on carriage shaft 142, carriage drive belt 134 and rail runner 140 are arranged inside a large cowl 138. An advantage of arranging these features of the unprinter module 100 inside the cowl 138 is that dust surrounding the unprinter may be substantially excluded by a filter over the preferred air intake port and further there is no slot required for any linkage passing through the large cowl 138. Therefore, the need for cleaning processes due to dust from the environment surrounding the unprinter are substantially reduced (although it will be understood that the optical devices may be cleaned on a regular basis due to removed print debris settling on these devices and more limited ingress along the media feed path).

Since the laser light beam does not exit the cowl 138, the unprinter is safer to use. As shown in FIG. 2, the unprinter module 100 is provided with a contact image sensor 110 and an opto-coupler 108 which interacts with the carrier 104 features. These optical elements are configured to sense a location of print on the paper 112 which is fed to the unprinter. As the encoder and the carrier drive motor 146 provide relative position, the opto-coupler 108 interacts with the carrier 104 features to allow determination an absolute position of the carriage referred to as “home”.

In embodiments inflection/biasing features 114 are provided on one or both sides of the print removal area which cause inflection in the paper path directing paper 112 away from the scanning gap. As outlined above, this prevents paper 112 from catching at edges when fed through the unprinter module 100.

Thus the paper guide comprises an inflection 114 to one or both sides, preferably to each side, of a laser ablation “unprinting” region of the device. In preferred embodiments the paper guide defines a guide surface both above and below the media path (although a guide surface on just one side of the media path may be employed). A guide surface may be defined by a continuous plate but in some preferred embodiments a guide surface is defined by a series of raised features such as ribs, for example running longitudinally along a direction of media movement. The guide surface underlies, or lies to each side of, the media and generally constrains the media for unprinting.

In preferred embodiments an inflection in the guide surface(s) comprises a region of the media guide surface(s) at which there is a downwards transition to a lower level (with respect to the ablation side of the paper transport), prior to the ablation region. In embodiments there may be a similar upwards transition beyond the ablation region. Here “downwards” and “upwards” are defined with respect to a forward direction of motion of the paper or other media past the ablation region. Providing both downwards and upwards inflections, as well as facilitating handling of pre-used paper for unprinting, also facilitates bi-directional transport of paper through the device. (Note that in FIG. 2, the sheet of paper 112 is simplistically taking a direct straight line path shown across this region whereas in practice the inflection is arranged to cause the paper to strike the upper guide surface and direct it towards the bottom guide surface as it passes the laser unprinting region).

As illustrated, in embodiments substantially the whole width of the paper is accessible to the laser in the ablation region. Optionally the media feed system may use a controlled relative difference in the drive speed of the rollers immediately before and after the unprinting line to provide either tension in the media or to run a slack region of media between the rollers.

Biasing nip rollers 132 are provided at intervals less than the length of media to be transported through the device. Media drive rollers 116 cooperating with the nip rollers 132 are arranged in the feed-through of the unprinter module 100 to control movement of the paper 112 in the unprinter.

The unprinter module 100 further comprises sensors 118 for reading marks on the paper 112. When unprinting the paper 112, it may be marked with a label, message and/or code to indicate that the paper 112 has been unprinted.

Filter detection opto-couplers 120 may be provided to ensure that the device is only operated while filters are inserted into the unprinter module 100.

It is to be noted that the entire upper assembly on its media guide plate may be mounted to hinge up or otherwise provide access to the paper path to allow clearance of jams. This may cooperate with a switch or opto-coupler to detect that the assembly is in position prior to operation.

The unprinter module 100 further comprises a manifold 124 comprising a debris chamber 128 and filters 126.

The debris chamber 128 may be a removable cartridge. Preferred embodiments of the debris chamber 128 are outlined above, and include, for example, a serpentine air-flow path to permit settling of removed print debris in the debris chamber 128.

Filters 126, in this example in cartridges, are provided beyond the debris chamber 128 along the air-flow path. The filters 126 may be, for example, carbon filters and/or nano-particles filters.

As outlined above, it is preferable to place the filters 126 on the side of the debris chamber 128 facing away from the area at which print is removed from the paper 112. This allows that the majority of the removed print debris is collected in the debris chamber 128, which increases the life-time of the filters 126.

In this embodiment, a fan 122 is placed behind the manifold 124, sucking air out of the inner part of the unprinter module 100. As outlined above, in alternative embodiments, the fan 122 is arranged on the opposite side to blow air into the inner part of the unprinter module 100. It will be understood that a plurality of fans 122 may be provided on one or both sides of the unprinter module 100.

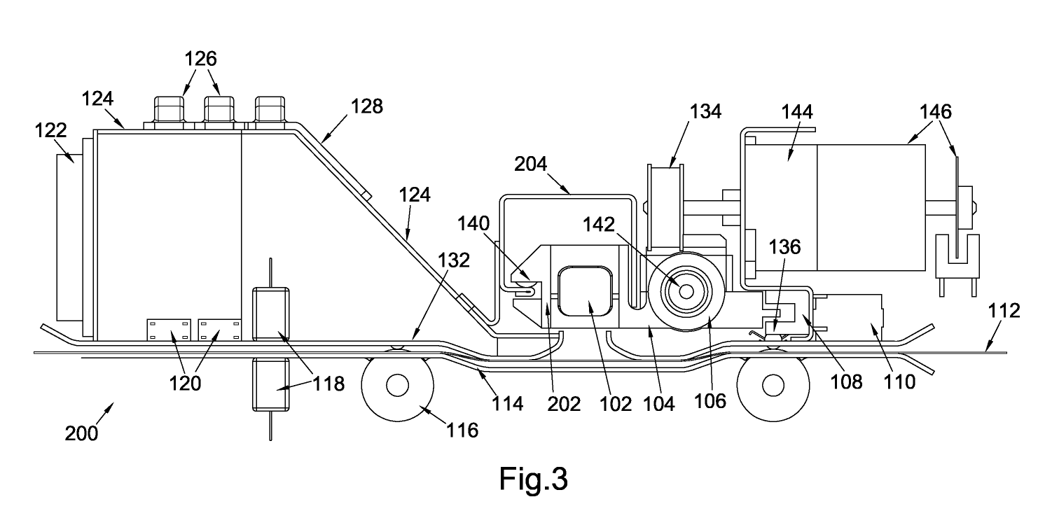

FIG. 3 shows a schematic, cross-sectional side-view of an unprinter module 200 according to a second embodiment of the unprinter.

In this example, the large cowl 138 is replaced with a small cowl 204. Merely the mirror 102, the rail runner 140 and a part of the carrier 104 are arranged inside the cowl 204.

An air baffle 202 is provided inside the cowl 204 to protect other (optical) sensors and the mirror 102 from debris accumulation (for small and large cowl versions).

A linkage is provided in the carrier 104 where is passes through the small cowl 204 between the elongated carriage bearing 106 and the mirror 102 in order to allow the mirror to be driven from outside of the cowl. A disadvantage of this embodiment compared to use of the large cowl 138 is that a long channel is used in the cowl 204 for the linkage to slide along. This may also be used as the air intake, or a contribution to it. However, since it performs two functions its design may be compromised and it is more difficult to effectively filter ingress of dust from outside the cowl. For this reason the large cowl 138 is the preferred embodiment.

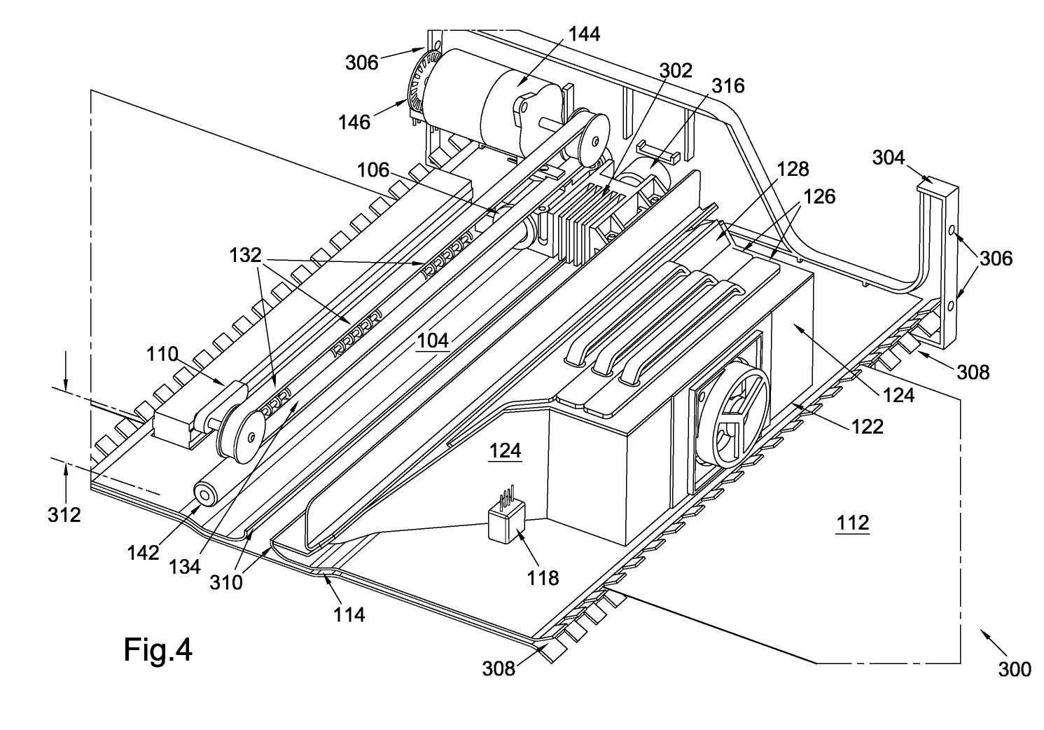

FIG. 4 shows a schematic perspective view of an unprinter module 300 of an unprinter. Some of the elements of the unprinter have been removed for clarity.

As can be seen, a laser entry port 316 with a baffle is provided in the unprinter module 300 in order to protect the laser light source from debris and dust accumulation.

Carriage cooling vanes 302 are arranged in the unprinter module 300 on the carrier 104 for thermal management of the carrier 104.

In this example, a plurality of location features 306 for module alignment is provided on a side plate 304 (only one side plate 304 is shown for simplification).

As outlined above, it may be preferable to accelerate or decelerate the carrier 104 at edge regions of the unprinter module 300. Therefore, acceleration and deceleration regions 312 are provided on each side of the module 300. It may be preferable to provide for a longer travel of the carrier 104 than may be required just for the paper 112 width. The acceleration and deceleration regions 312 may thereby be provided at regions beyond areas at which the paper 112 is fed through the module 300.

The unprinter module 300 further comprises paper control features 308 on each side of the module 300. It will be appreciated that paper control features 308 are shown having castellation such that they may interface with mating and overlapping features on an adjacent module so as to provide reliable media feeding in either direction. It will be appreciated that paper control features 308 may be formed without castellation features but fed from a narrow track inserted into the funnel so formed when paper 112 is fed to the module 300 from one side only.

Further paper control features 310 are provided in a centre region of the unprinter module 300. It will be appreciated that a gap must be provided in the print removal region where the print is removed from the paper 112 by the laser light beam. Paper control features 310 are configured to avoid catching of the paper 112 at the edges forming the ends of the gap through which the laser light can penetrate. Therefore, as can be seen in FIG. 4, the paper control features 310 are curved upwards. Furthermore, narrow slots may be provided in the edges of the paper control features 310. The closed end of the narrow slots may also be slightly bent upwards so as to avoid catching of the paper 112 when being guided through unprinter module 300.

Therefore, any edges defining the gap through which the laser light beam may penetrate to expose the paper 112 may be bent upwards to avoid snagging/catching of the paper 112 when being fed through the print removal area.

Additionally, wires (not shown) with gaps between them may be arranged passing through the aforementioned narrow gaps in the control feature edges 310 across the gap through which the laser light can penetrate to remove print from the paper 112. These wires are used to guide the paper 112 and prevent the paper 112 from catching at edges of the paper guide defining the air gap. The wires span across the gap in a direction generally parallel to the direction of movement of the paper 112 in the unprinter module 300. Preferably, the wires are tilted, i.e. they span across the gap in a direction which is not exactly parallel to the direction of movement of the paper 112 in the unprinter module 300. This allows for the laser light beam to “see” all areas of the paper 112 on adjacent swathes of the mirror when it is guided across and underneath the gap, in particular when the laser light beam is only projected onto the paper 112 at a 90 degree angle. Hence, if an area on the paper 112 is not accessible by the laser light beam during a first swathe, it may be accessible during a later swathe once the paper 112 has been fed through the unprinter module 300 further.

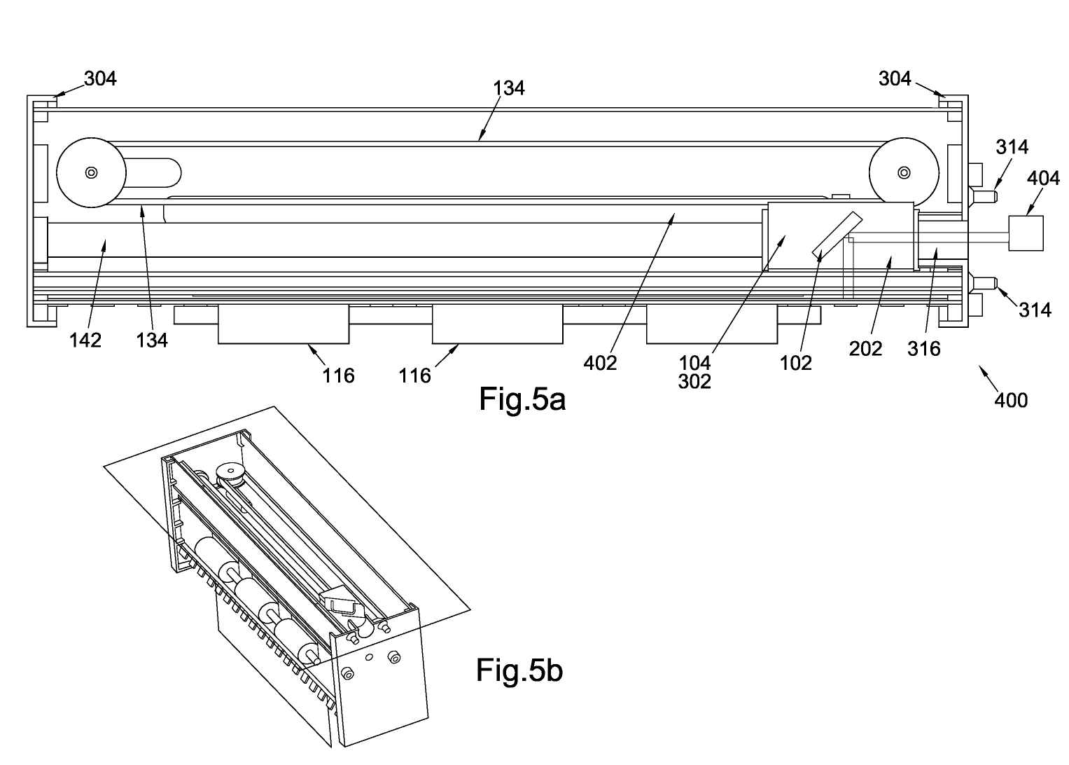

FIG. 5a shows a schematic, cross-sectional front view of an unprinter module 400. FIG. 5b shows the corresponding, schematic perspective view of the module 400.

In this example, the laser light beam generated by the laser light source 404 is reflected by the mirror 102 such that it impinges on the paper 112 at a 90 degree angle.

An air inlet 402 is provided in the large cowl 138 allowing air to be sucked into the large cowl 138 to generate an air flow to extract the removed print debris. An additional filter may be provided on an inner or outer side of the air inlet 402 to avoid sucking dust from an environment of the unprinter into the relatively clean area of the large cowl 138.

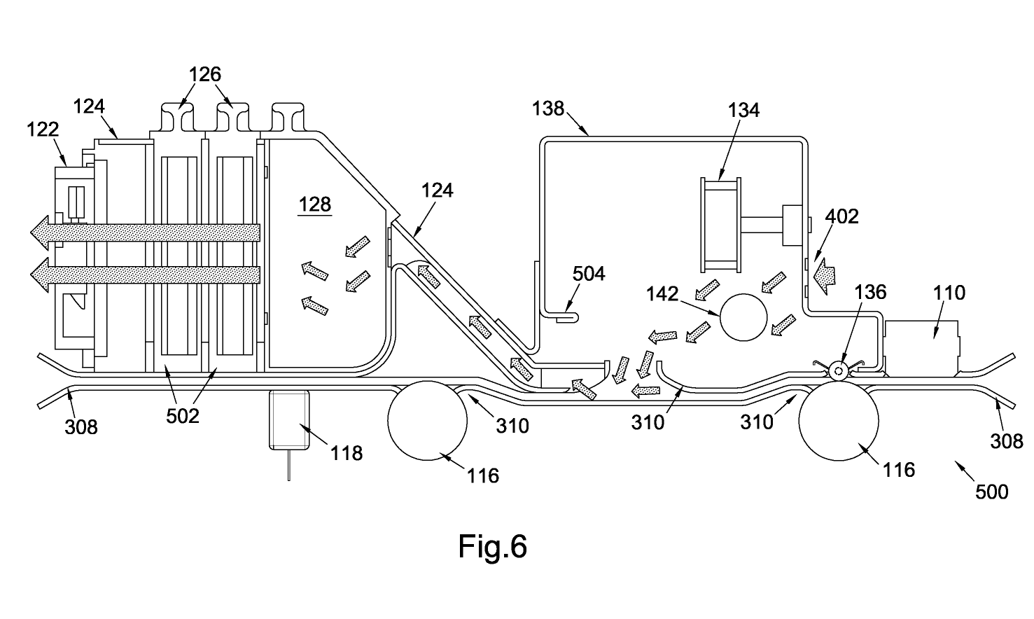

FIG. 6 shows a schematic, cross-sectional side-view of an air-flow path in an unprinter module 500 according to embodiments described herein. The air-flow path, which is indicated as yellow (bright) arrows (and black arrows in the debris chamber 128), is generated by fan 122.

Air may enter the unprinter module 500 via air inlet 402. The air-flow then collects removed print debris removed from the paper and provides it via an extraction system to the debris chamber 128. The majority of the removed print debris may be collected in the debris chamber 128. However, some particles may not be captured in the debris chamber 128 so are carried to the filters 126. Once the air has been filtered by the debris chamber 128 and the filters 126, it can exit the unprinter module 500 via fan 122.

It is to be noted that in FIG. 6, various elements are not visible due to the position of the cross section (for clarity), in particular features arranged in the cowl 138, such as the mirror 102 and the carrier 104. Guide rail 504 is provided to guide the rail runner 140. Cartridge slots 502 are provided in the unprinter module 500 for receiving filters 126.

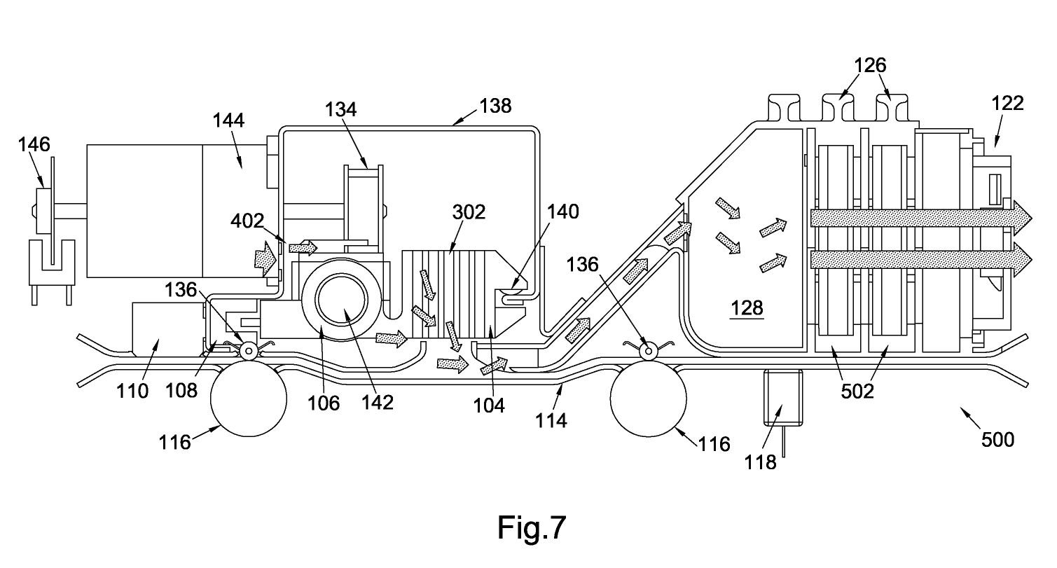

FIG. 7 shows the unprinter module 500 of FIG. 6 from the opposite side. The rear side of the carrier is visible in this view with the mirror facing away so not visible.

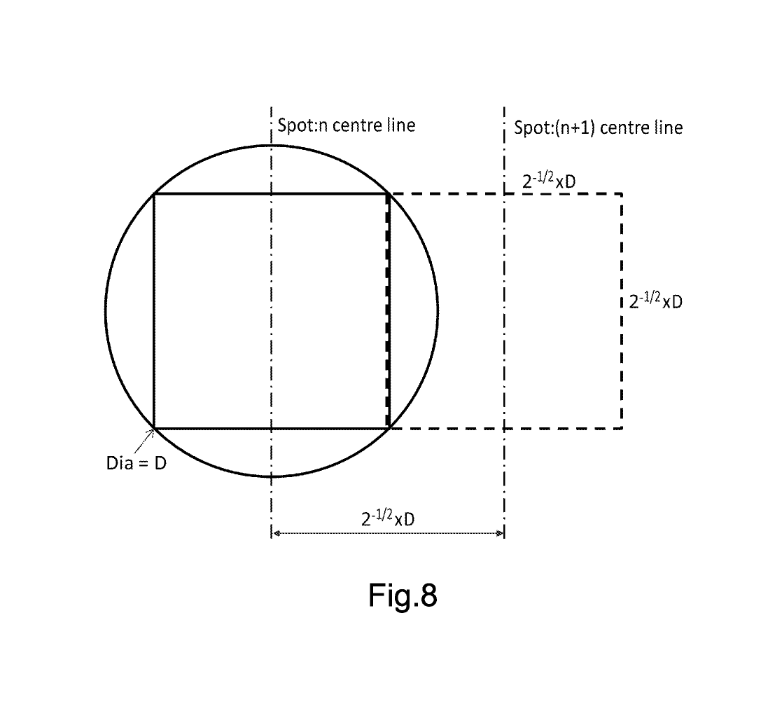

FIG. 8 shows a schematic of a spot size illustration of a laser light beam according to embodiments described herein.

It will be appreciated that the laser light beam may be operated continuously while the location of the mirror 102 is changed to expose different areas of the paper 112 to the laser light beam. However, preferably, the laser light beam is repetitively pulsed so as to be synchronised with the continuous movement of the mirror and may further be selectively pulsed to only expose areas of the paper 112 on which print has been detected. The laser spot of a pulse n is indicated in FIG. 8 as a solid-line circle with a diameter D. As outlined above, the optimum separation between pulse n and an adjacent, subsequent pulse n+1 (that is the distance between the centres of the circles of pulse n and n+1, respectively) for speed of unprinting the whole paper is around 2^{-1/2}×D. In some embodiments described herein, the laser spot has a diameter of D>0.05, 0.1 or 0.2 mm to allow for normal positional tolerances in mechanical systems but may be significantly larger.

FIG. 9 shows distortion of a laser light beam using a mirror with a convex, concave, curved or other complex form, or a flat mirror which is tilted such that the laser light beam impinges on the paper 112 at an angle smaller than 90 degrees. The arrow “A” indicates a direction of movement of the paper 112 in the unprinter. As outlined above, it may be preferable to distort the laser light beam such that it is longer in a direction of paper movement (direction “A”) than in a direction perpendicular thereto. Therefore, mechanical alignment in the direction of “A” may be less demanding in order to allow abutting or overlapping of adjacent swathes. A laser spot with an original diameter of, e.g. about D=1 mm may be distorted to be 4-5 mm long in the direction of paper movement (direction “A”) when it impinges on the paper 112.

### Laser and Beam Shaping

In embodiments the laser employed in the optical system provides a pulsed output with a pulse length in the range 0.1 ns to 10 ns, more preferably 0.5 ns to 5 ns. Preferably the laser output provides a peak laser pulse power of at least 30 KW, more preferably at least 50 kW or 90 KW, for example in the range 50-100 KW. Preferably the fluence of the laser on the media is in the range 1.0 to 1.6 or 2.0 J/cm² although a lower fluence, for example down to low as 0.1 J/cm² may suffice. Preferably a wavelength in the green is employed, for example in the range 490-580 nm. In one preferred embodiment a diode-pumped solid state laser is employed, more particularly a frequency doubled Nd:YAG laser.

The optical energy intensity profile influences the heat distribution during laser ablation. Gaussian energy intensity profiles result in concentrated hotspots on the material where temperature is significantly higher in comparison to its surroundings. The received wisdom is that the heat distribution generated by a Gaussian beam has advantages during ablation, marking and cutting of materials, this is not the optimum for laser removal of toner from paper. More particularly the inventors have found that ablation of toner works best with a threshold energy per unit area (fluence) to be achieved over a relatively short time so as to minimise thermal heat transfer to the media substrate causing damage. A Gaussian beam having a peak that is significantly above the threshold but with extremities below the threshold is inefficient as it wastes energy in the central portion of the beam spot and high heat concentrations can have a negative effect on the paper substrate.

For these reasons a flat-top (“top-hat”) beam is preferred for laser removal of toner from paper. This type of beam has an optical energy intensity profile which is flat over most of the covered area, leading to a more uniformly distributed intensity profile, which in turn leads to a more uniform heat distribution on the target. A Gaussian beam can be transformed into a flat-top (“top-hat”) beam of either round, rectangular, square, line or other shape by employing a beam shaping element such as a diffractive optical element. In addition to the benefits associated with the more uniform temperature distribution, achieving the required ablation energy threshold whilst managing thermal damage risk to the substrate, flat-top beams also have the potential to increase the speed of the unprinting process by creating a larger useful spot area allowing a reduced overlap (increased step size) between successive pulses.

The shape of the beam may be defined by selecting the lasing device geometry so that the laser source inherently provides the desired shape but it may also be defined after the laser source output, by beam shaping. This beam shaping is preferably performed after the laser source and preferably before the mirror, in particular to create a generally rectangular (line) or square shape.

### Unprinting Module

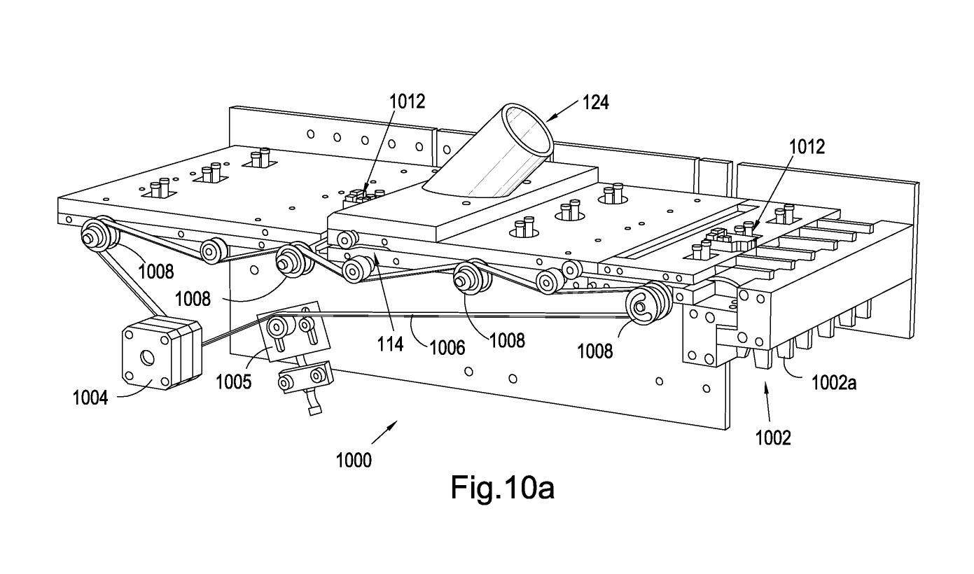

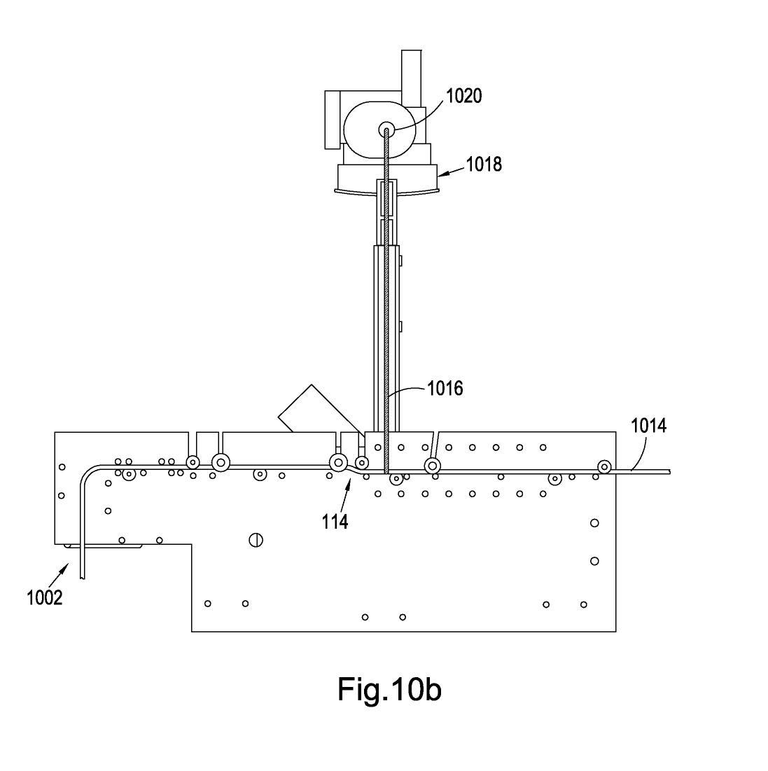

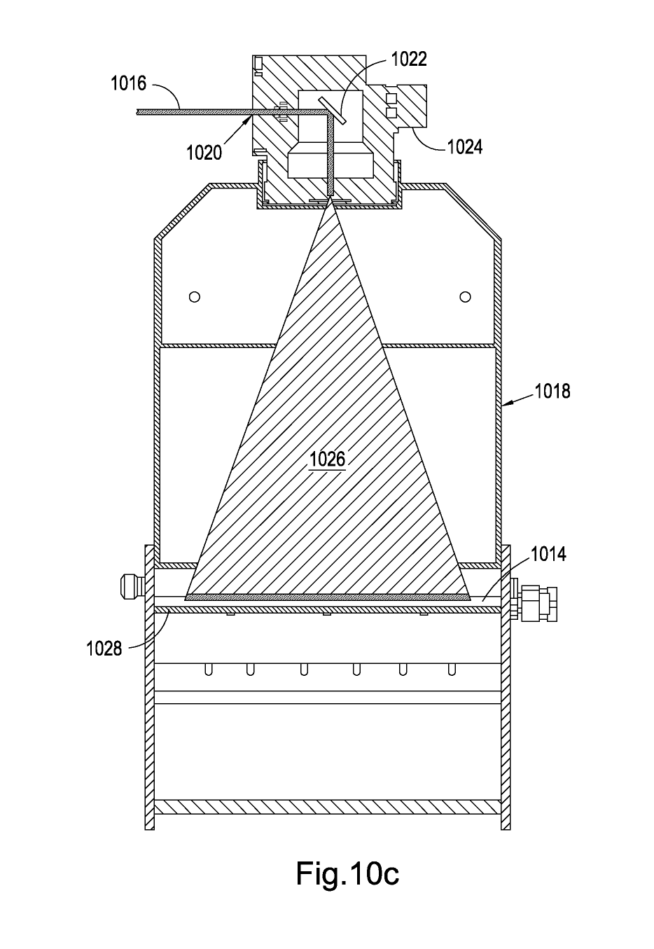

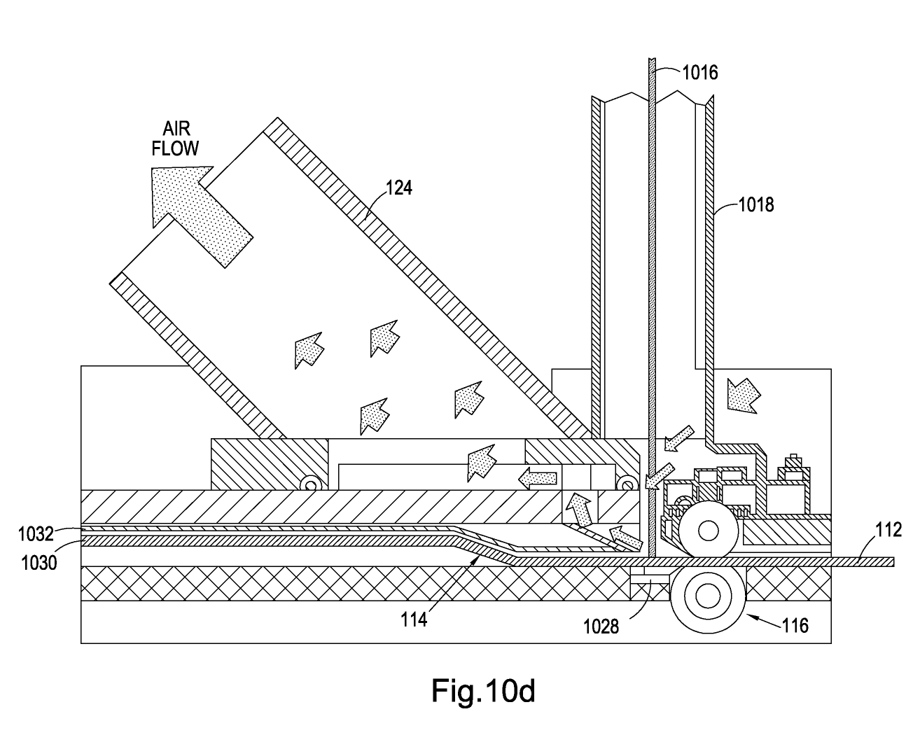

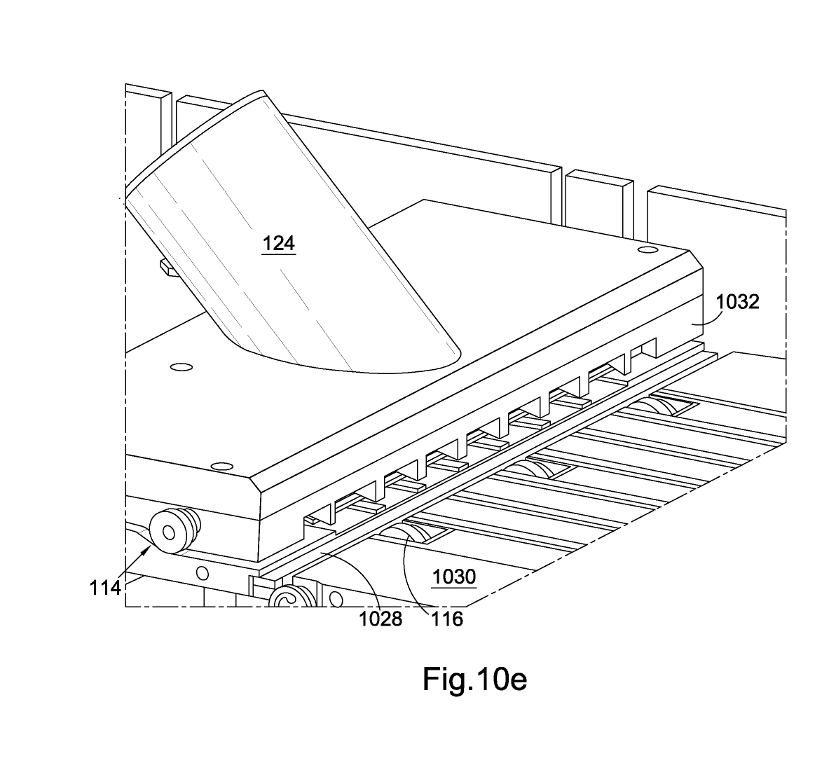

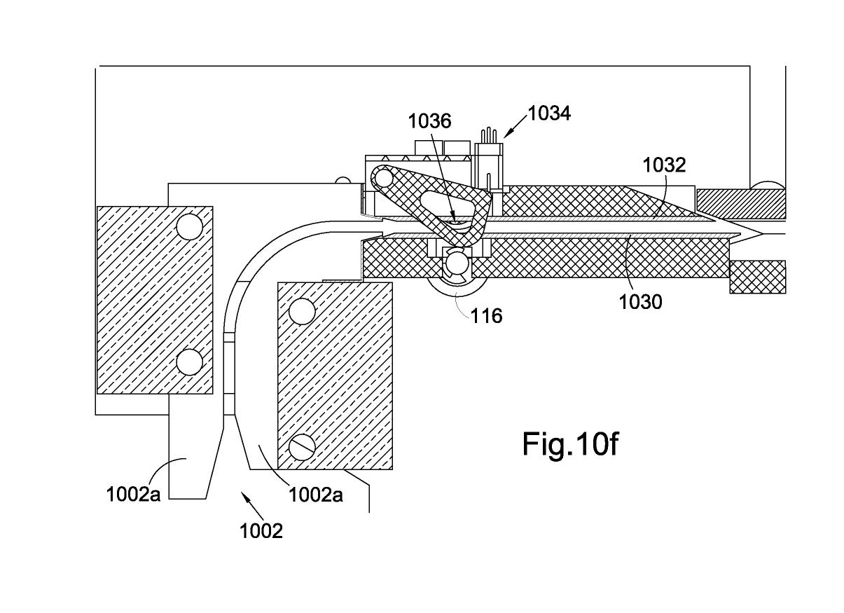

Referring now to FIG. 10, this shows a further example of an unprinting module 1000 for an unprinter, in which like elements to those previously described are indicated by like reference numerals.

Thus FIG. 10a shows a perspective view of the module illustrating paper feed input 1002 comprising a plurality of fin-like paper guiding features 1002a. As illustrated the paper feed is from beneath the module, for example from a sheet feeder, to utilise vertical space and reduce the footprint of the unprinter. A media drive motor 1004 has a belt 1006 to drive a media transport mechanism comprising a plurality of rollers 1008 (driving the previously described media drive rollers 116) and tensioner 1005. In FIG. 10a the media travels from right to left and the laser scan line/ablation region (not shown) is to the left of exhaust duct (manifold) 124. Optical sensors 1012 sense the media position in the module.

FIG. 10b shows a view from the side of the media feed path 1014, laser beam 1016, and laser beam housing 1018 substantially enclosing the beam and scanner and having a laser input port 1020. FIG. 10c shows a corresponding view along the media movement direction, showing the high speed scanner, here comprising an oscillating mirror 1022 driven (in this example) by a motor 1024. Region 1026 shows the extent of the scanned beam. Also shown in FIG. 10c is a diffuser plate 1028, in embodiments a non-reflective plate able to absorb laser energy in a failsafe mode (for example if paper is not present or has a hole). The diffuser plate may comprise a brushed, black anodised aluminium strip plate.

It is undesirable to have significant reflections of a laser beam back towards the laser. The media guide below the location of the laser scan may be somewhat reflective for example if made from steel or other metal or even plastic. Generally the incident laser beam will be at an angle such that there is no direct path back to the laser source except for the area immediately on axis with the laser. However, the energy levels are relatively high so it is desirable to take an additional precaution. A non-reflective material having adequate thermal heat sinking capability is preferably, therefore, installed below the unprinting line. In a preferred embodiment the diffuser 1028 comprises a strip of aluminium having a textured surface (eg brushed, blasted or eroded); it may be black-anodised. This is intended to be the terminal element of the optical system and to absorb the incident laser beam energy if there is no media above it. This situation may occur if, for example, a fault (more particularly an undetected fault) occurs in the media transport, or if the media item has a hole in it or is out of position or not to a specified dimension.

FIG. 10d shows a longitudinal cross-section view of the beam delivery section of the module, showing lower 1030 and upper 1032 media guides and inflection 114. Optionally diffuser plate 1028 may be part of the lower guide or formed as a region on the lower media guide. As illustrate the media guides comprise plates but a media guide may also be formed of ribs having gaps between and lacking a continuous surface. FIG. 10e shows a perspective view of part of the same region. FIG. 10f shows details of the media input region, showing the media path curving around a corner from vertical to horizontal, and illustrating a further optical media sensor 1034 and a media nip/pinch roller 1036.

In the example of FIG. 10 the media is transported in one direction rather than bi-directionally (and hence there is one inflection rather than two inflections 114), but the skilled person will recognise that it may be adapted to bi-directional operation.

No doubt many other effective alternatives will occur to the skilled person. It will be understood that the invention is not limited to the described embodiments and encompasses modifications apparent to those skilled in the art and lying within the spirit and scope of the claims appended hereto.

1. A print removal device for removing print from a print-carrying medium, the print removal device comprising:
a feed system for receiving said print-carrying medium and guiding said print-carrying medium through said print removal device; and
a system to remove said print from said print-carrying medium, by a laser light source for providing a controllable laser light beam to remove said print from said print-carrying medium;
wherein said feed system comprises a media guide comprising an inflection configured to bias said print-carrying medium away from a scanning gap between paper control edges through which said laser light source impinges a portion of the print-carrying medium exposed through the gap.

2. A print removal device as claimed in claim 1, wherein said media guide comprises a first said inflection at a first location of said media guide and a second said inflection at a second location of said media guide, wherein said first and second locations are located on opposite sides in a direction of said guiding of said print-carrying medium through said print removal device with respect to an area of said print removal device at which said print-carrying medium is exposed to said laser light beam.

3. A print removal device as claimed in claim 1, including a media guide which comprises a plurality of wires for guiding said print-carrying medium through said print removal device, and wherein one or more gaps between said plurality of wires are configured to allow said print-carrying medium to be exposed to said laser light beam.

4. A print removal device as claimed in claim 3, wherein said wires are deployed at an angle greater than zero with respect to a direction of motion of said print-carrying medium in said print removal device such that said laser light beam can access all parts of said print-carrying medium in an area of said print removal device at which said print-carrying medium is exposed to said laser light beam.

5. A print removal device as claimed in claim 1, the print removal comprising:
a controllable reflector for reflecting said laser light beam onto said print-carrying medium to remove said print from said print-carrying medium.

6. A print removal device as claimed in claim 5, further comprising a print sensor for sensing a position or area occupied by said print on said print-carrying medium, and further comprising a controller for controlling said controllable reflector, wherein said controllable reflector is controlled to reflect said laser light beam onto said print-carrying medium to remove said print from said print-carrying medium in response to said sensing, wherein said controlling of said controllable reflector comprised at least one of:
controlling a position of said reflector in a first direction having a component which is perpendicular to a direction of movement of said print-carrying medium in said print removal device, wherein said first direction is substantially parallel to a plane of said print-carrying medium; and
rotating said reflector for varying a second direction of said reflected laser light beam.

7. (canceled)

8. A print removal device as claimed in claim 6, wherein said controlling and/or rotating is configured such that two or more laser light beam-exposed regions of said print-carrying medium overlap.

9. A print removal device as claimed in claim 5 wherein said laser is pulsed, wherein said controllable reflector is controlled to scan said laser along lines perpendicular to a direction of travel of said print-carrying medium, and wherein said controllable reflector is controlled to overlap spots of said pulses by a first percentage along a said scan line and by a second different percentage between said scan lines.

10. A print removal device as claimed in claim 5, wherein said reflected laser light beam impinges on said print-carrying medium substantially at a right angle.

11. (canceled)

12. A print removal device as claimed in claim 5, wherein said reflected laser light beam has a shape which is longer in a fourth direction than in a fifth direction when impinging on said print-carrying medium, wherein said fourth direction is substantially parallel to a direction of movement of said print-carrying medium in said print removal device and wherein said fifth direction is substantially perpendicular to said direction of movement of said print-carrying medium in said print removal device.

13. A print removal device as claimed in claim 5, further comprising one or more optical elements to modify a transverse profile of said laser light beam, in particular towards a square or rectangular shape or to flatten an intensity profile of the beam

14. A print removal device as claimed in claim 5, further comprising a collection unit for collecting said removed print.

15. A print removal device as claimed in claim 14, wherein said collection unit comprises one or more filters.

16. A print removal device as claimed in claim 5, further comprising an extraction system for extracting said removed print from an area of said print-carrying medium at which said print has been removed.

17. A print removal device as claimed in claim 16, wherein said extraction system is configured to provide an air-flow in said print removal device, wherein said air-flow carries particles of said removed print, and wherein an air-flow direction of said air-flow is substantially perpendicular to a beam direction of said controllable laser light beam provided by said laser light source.)

18. A print removal device as claimed in claim 1, wherein the
system to remove said print from said print-carrying medium is configured to remove said print along a swath line by a laser light source for providing a controllable laser light beam and the device further comprising:
an extraction system for extracting particles of said removed print; and a collection chamber connected to said extraction system, wherein said collection chamber is configured to collect removed print debris extracted by said extraction system;
wherein said extraction system includes an air inlet having an inlet aperture shape adapted to match said swath line, to entrain said particles of removed print from said swath line; and/or
wherein a cross-sectional area of air flow through said extraction system enlarges at a collection chamber region such that a speed of said air flow reduces to promote settling of said particles in said collection region.

19. A print removal device as claimed in claim 18, further comprising one or more filters, wherein said collection chamber is arranged between said extraction system and said one or more filters.

20. A print removal device as claimed in claim 1, the print removal device comprising:
an extraction system for extracting particles of said removed print; and a collection chamber connected to said extraction system, wherein said collection chamber is configured to collect removed print debris extracted by said extraction system, wherein said collection chamber comprises an electrical element for applying an electric field to particles of said removed print received from said extraction system in said collection chamber for electrostatic collection of said particles.

21. A print removal device as claimed in claim 20, further comprising a charging device for electrically charging particles of said print prior to receiving said removed print in said collection chamber, wherein said charging device is configured to charge said particles before and/or after said removal of said print by said system.

22. A print removal device as claimed in claim 1, the print removal device comprising:
a collection system configured to collect said removed print; and
a replacement determination system for predicting and/or indicating when an element of said collection system should be replaced, said replacement determination system comprises at least one of a list consisting of:
a flow sensor for sensing an air-flow generate by a fan of said print removal device, wherein said air-flow carries particles of said removed print;
an electrical sensor for measuring a power consumption and/or a speed of said fan;
a pressure sensor for measuring an air pressure in said print removal device;
a sensor for measuring a weight or volume of said collected, removed print; and
a device for determining and/or counting one or more of, a total usage time of said laser light source, a total area of said print removed from said print-carrying medium, and a total number of unprinted print-carrying media.

23-26. (canceled)
